(19) United States
(12) Patent Application Publication
(10) Pub. No.: US 2016/0188004 A1
(43) Pub. Date: Jun. 30, 2016

(54) Method and Device for the Compressed Transfer of Signals of an Operating Element Having Movement Coordinates in a Vehicle

(71) Applicant: Daimler AG, Stuttgart (DE)

(72) Inventor: Volker Entenmann, Affalterbach (DE)

(73) Assignee: Daimler AG, Stuttgart (DE)

(21) Appl. No.: 14/910,603

(22) PCT Filed: Jun. 20, 2014
(86) PCT No.: PCT/EP2014/001680

§ 371 Date: Feb. 5, 2016

(30) Foreign Application Priority Data
Aug. 9, 2013 (DE) 10 2013 013 362.9

(51) Int. Cl. G06F 3/038; B60K 35/00; G06F 3/0484; G06F 3/0488; G06F 3/0354; G06F 3/0482

(52) U.S. Cl. CPC G06F 3/0383; G06F 3/03547; G06F 3/0482; G06F 3/04842; G06F 3/0488; B60K 35/00; B60K 2350/928; B60K 2350/106

(57) ABSTRACT

A method and device for compressed transfer of signals of an operating element, to a display unit in a vehicle is disclosed. The method includes transmission of an optical signal to a surface of the operating element, receiving of an optical signal reflected by a finger of a user on the surface of the operating element in a predetermined scanning cycle, conversion of the reflected optical signal into a digital signal that has relative movement coordinates of the finger in a first direction and a perpendicular second direction, compression of the relative movement coordinates of the finger by a non-linear compression characteristic curve for obtaining a compressed digital signal, transfer of the compressed digital signal to the display unit and decompression of the compressed digital signal in the display unit by a non-linear decompression characteristic curve that is inverse to the non-linear compression characteristic curve.

### BACKGROUND AND SUMMARY OF THE INVENTION

The invention relates to a method and a device for the compressed transfer of signals of an operating element having movement coordinates in a vehicle.

An operating unit for a steering wheel of a motor vehicle is known from DE 10 2011 112 568 A1. The operating unit comprises an operating device with which an operating input executed by a finger is able to be registered, and an operating surface element for positioning the finger. The operating device furthermore comprises a transmission unit for emitting an optical signal to the finger. The optical signal is reflected by the finger and registered by a receiving unit and an operating input is determined from the registered optical signal, wherein the transmission unit and the receiving unit are arranged on a side of the operating surface element facing away from the finger. A movement direction of the finger is transferred in the form of delta X and delta Y coordinates. Delta X describes the route which a finger covers in a scanning cycle in the X direction. Delta Y describes, accordingly, the covered route in the Y direction, which is perpendicular to the X direction.

With this type of transfer, the entire speed range of the finger can be represented with very high resolution. However, due to the very high resolution and the transfer of the coordinates, a high bandwidth of a data bus is required. A 16-bit transfer is required as a result of this high bandwidth, which, however, for example with the use of a cost-effective LIN or Local Interconnect Network bus, is not available in a vehicle.

The object of the invention is therefore to create a method and a device which use an operating element by using optical signals and minimize a required amount of data, the data being transferred from a steering wheel of a motor vehicle via a data bus to a display unit in the vehicle.

This object is solved by the features specified in the independent claims.

Further advantageous embodiments of the present invention are the subject matter of the dependent claims.

According to a first aspect, a method for the compressed transfer of signals of an operating element having movement coordinates to a display unit in a vehicle includes a transmission of an optical signal to a surface of the operating element, a receiving of an optical signal reflected by a finger of a user on the surface of the operating element in a predetermined scanning cycle, a conversion of the reflected optical signal into a digital signal that has relative movement coordinates of the finger in the predetermined scanning cycle in a first direction and a second direction that is perpendicular to the first direction, a compression of the relative movement coordinates of the finger in the first direction and the second direction by means of a non-linear compression characteristic curve for obtaining a compressed digital signal, a transfer of the compressed digital signal to the display unit, and a decompression of the compressed digital signal in the display unit by means of an non-linear decompression characteristic curve that is inverse to the non-linear compression characteristic curve.

The transfer of movement coordinates of the finger on a data bus with low bandwidth is thereby allowed. The error arising by compression and decompression is selected in such a way that it is below the perception threshold of the user for speed and is therefore unable to be perceived by him. More precisely, the compression characteristic curve and the decompression characteristic curve are formed in such a way that low speeds of the finger are resolved more finely than higher speeds of the finger, wherein precision of the operating element is maintained. At higher speeds of the finger, no fine resolution is required since, at higher speeds of the finger, a digital noise is lower than at lower speeds of the finger. The amount of data to be transferred may be reduced to 8-bit per coordinate in this way.

The compression is carried out in such a way that the digital signal is compressed more strongly with increasing speed depending on a speed derived from the movement coordinates.

According to a further embodiment, the compression and decompression are carried out in such a way that a maximum error between a value of the digital signal and a value of a decompressed signal is less than or equal to five percent and the compressed digital signal has a maximum of 8 bits.

According to a further embodiment, the decompressed digital signal in the display unit is represented as a movement of a pointer displayed in the display unit, a movement of a content displayed in the display unit or a movement of a selection of menu items displayed in the display unit.

According to a further embodiment, the operating element is provided in a steering wheel of a vehicle and the compression of the digital signal is carried out in an electronics unit of the steering wheel.

According to a further embodiment, the operating element is an optical operating element, preferably an optical finger navigation module or OFN.

According to a second aspect, a device for the compressed transfer of signals of an operating element having movement coordinates to a display unit in a vehicle has a first device for the transmission of an optical signal to a surface of the operating element, a second device for receiving an optical signal reflected by a finger of a user on the surface of the operating element in a predetermined scanning cycle, a third device for the conversion of the reflected optical signal into a digital signal that has relative movement coordinates of the finger in the predetermined scanning cycle in a first direction and a second direction that is perpendicular to the first direction, a fourth device for the compression of the relative movement coordinates of the finger in the first direction and the second direction by means of a non-linear compression characteristic curve for obtaining a compressed digital signal, a fifth device for the transfer of the compressed digital signal to the display unit, and a sixth device for the decompression of the compressed digital signal in the display unit by means of an non-linear decompression characteristic curve that is inverse to the non-linear compression characteristic curve. The fourth device carries out the compression in such a way that the digital signal is compressed more strongly with increasing speed depending on a speed derived from the movement coordinates.

According to the second aspect, the same advantages are achieved as described before with respect to the first aspect.

According to a further embodiment, the fourth device carries out the compression and the fifth device carries out the decompression in such a way that a maximum error between a value of the digital signal and a value of a decompressed digital signal is less than or equal to five percent and the compressed digital signal has a maximum of 8 bits.

According to a further embodiment, the display unit depicts the decompressed digital signal as a movement of a pointer displayed in the display unit, a movement of a content displayed in the display unit or a movement of a selection of menu items displayed in the display unit.

According to a further embodiment, the operating element is provided in a steering wheel of a vehicle and the fourth device is provided in an electronics unit of the steering wheel.

According to a further embodiment, the operating element is an optical operating element, preferably an optical finger navigation module or OFN.

The present invention is explained in more detail below by means of an exemplary embodiment with reference to the enclosed drawings.

### BRIEF DESCRIPTION OF THE DRAWINGS

FIG. 1 is a schematic depiction of an operating element in a steering wheel of a motor vehicle according to one exemplary embodiment of the present invention;

FIG. 2 is a schematic block diagram of components required for a data transfer according to the exemplary embodiment of the present invention;

FIG. 3 is a flow diagram of a process flow of the data transfer according to the exemplary embodiment of the present invention;

FIG. 4 is a detailed flow diagram of a step S500 of the flow diagram in FIG. 3;

FIG. 5 is a depiction of a non-linear compression characteristic curve; and

FIG. 6 is a depiction of a non-linear decompression characteristic curve that is inverse to the nonlinear compression characteristic curve in FIG. 5.

### DETAILED DESCRIPTION OF THE DRAWINGS

One exemplary embodiment of the present invention is described below,

It should be noted that a display unit described in the further course is a central display unit in a vehicle or a display unit in a combined instrument panel in a region in the vicinity of a steering wheel of the vehicle. The vehicle is preferably a motor vehicle.

Moreover, a combination of two display units in the vehicle by using several of the operating elements described below is possible, wherein a respective operating element belongs to each display unit. For example, with the use of both the central display unit and the display unit in the combined instrument panel of the central display unit, an operating element belongs to the central display unit and, in the combined instrument panel, another operating element belongs to the display unit. The operating element for the central display unit may be arranged on a right-hand side of the steering wheel and the other operating element for the display unit in the combined instrument panel may be arranged on a left-hand side of the steering wheel.

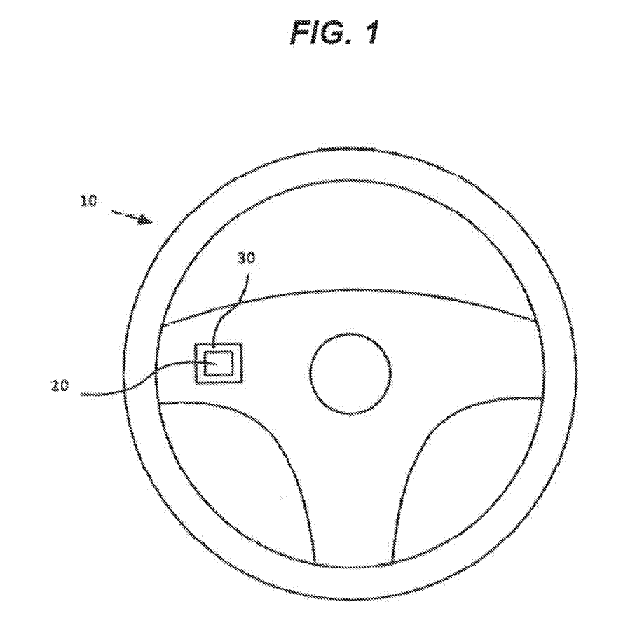

FIG. 1 shows a schematic depiction of an operating element in a steering wheel of a motor vehicle according to the exemplary embodiment of the present invention.

In FIG. 1, the reference numeral 10 denotes a steering wheel of a motor vehicle, the reference numeral 20 denotes an operating unit and the reference numeral 30 denotes an illumination device.

The steering wheel 10 of the motor vehicle may furthermore have two or more operating units 20. For example, one of two operating units 20 may be located on the left-hand side of the steering wheel 10 shown in FIG. 1, while the other of the two operating units 20 may be located on the right-hand side of the steering wheel 10. The illumination device 30 serves for improved orientation for a driver of the vehicle, such that the latter may operate the operating unit 20 or the operating units 20 securely, even in the presence of low ambient light. Further arrangements of the operating unit 20 are possible. An operating unit 20 may, for example, also be located separately from the steering wheel 10 in the vehicle.

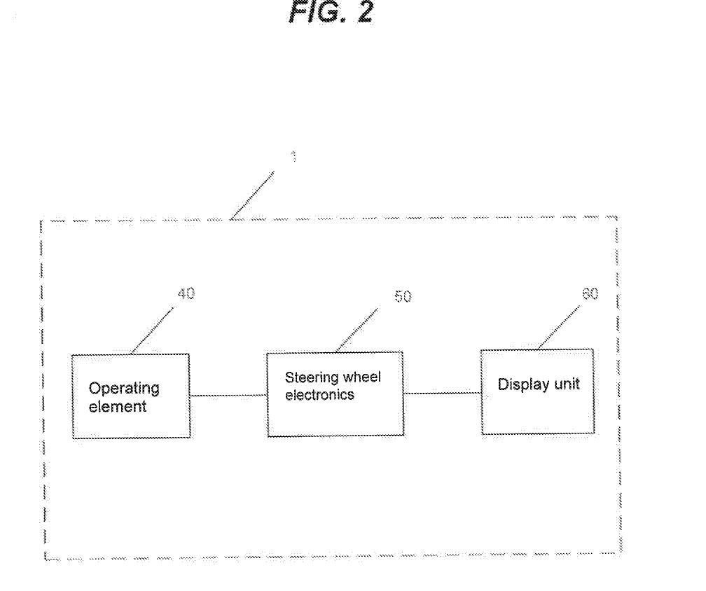

FIG. 2 shows a schematic block diagram of components required for a data transfer according to the exemplary embodiment of the present invention.

In FIG. 2, the reference numeral 1 denotes a vehicle, the reference numeral 40 denotes an operating element which is located in the vehicle 1, the reference numeral 50 denotes steering wheel electronics which are located in the steering wheel 10 of the vehicle 1, and the reference numeral 60 denotes a display unit in the motor vehicle 1.

The operating element 40 shown in FIG. 2 can be provided in the operating unit 20 shown in FIG. 1 or can be the operating unit 20 shown in FIG. 1, such that the statements made previously with respect to the operating element also apply for the operating element 40.

A selection can be made on the display unit 60 or the content of the display unit 60 can be controlled by the operating element 40. The steering wheel electronics 50 are provided between the operating element 40 and the display unit 60. A control of the display unit 60 is carried out in the steering wheel electronics 50. A compression of data emitted from the operating element 40 is also carried out in the steering wheel electronics 50, whereby there is no necessity for additional components.

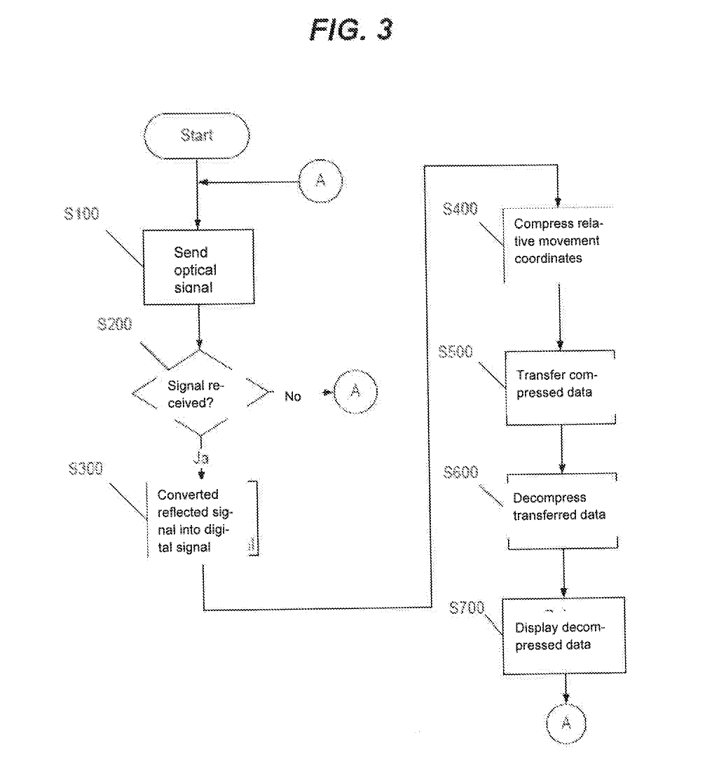

FIG. 3 shows a flow diagram of a process flow of the data transfer according to the exemplary embodiment of the present invention.

It should be noted that the process flow of the flow diagram in FIG. 3 is switched on, for example, after an initialization point, such as after switching on an ignition of the vehicle, and is carried out in repeating cycles until an end point, such as a switching-off of the ignition of the vehicle, is reached. Alternatively, the initialization point can, for example, be the point in time of starting an engine of the vehicle and/or the end point can be the point in time of switching off the engine of the vehicle. The initialization point can furthermore be relative to the point in time of the activation of the display unit and/or the end point can furthermore be relative to the point in time of the deactivation of the display unit. Other initialization points and end points are also possible according to the present application.

After starting at the initialization point, the process flow proceeds to step S100.

In step S100, an optical signal is sent to a surface of the operating element 40. After step S100, the process flow advances to step S200.

In step S200, it is decided as to whether a signal is received which has been reflected by a finger of a user or not. The signal is reflected if a finger of the user is located on a surface of the operating element 40. If the decision in step S200 is “NO”, the process flow reverts to step S100.

If the decision in step S200 is “YES”, the method advances to step S300. In step S300, the received optical signal reflected by the finger of the user in the operating element 40 is converted into a digital signal.

More precisely, the operating element 40 recognizes movement increments of a finger of a user in the direction of axes of a coordinate system of the operating element 40 and, with the aid of these recognized values, calculates sums of the movement increments of the finger of the user in the direction of the axes of the coordinate system of the operating element 40. Data which represents these sums, i.e., relative movement coordinates of the finger, is contained in the digital signal.

After step S300, the process flow advances to step S400.

In step S400, the relative movement coordinates which are contained as information in the converted digital signal are compressed in the steering wheel electronics 50 by means of a non-linear compression characteristic curve.

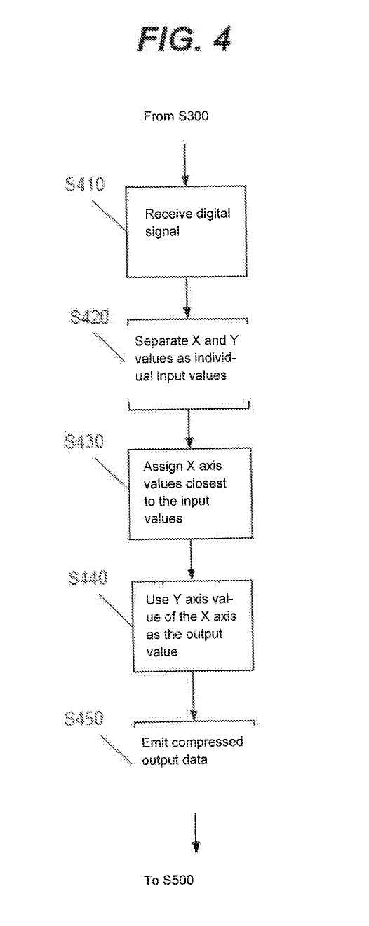

FIG. 4 shows a detailed flow diagram of step S400 of the flow diagram in FIG. 3.

In step S410, the digital signal converted in step S300 in FIG. 3 is received. After step S410, the process flow advances to step S420.

In step S420, the movement coordinates from the digital signal received in step S410 are divided into individual X and Y values and each value is used as an individual input value. After step S420, the process flow advances to step S430.

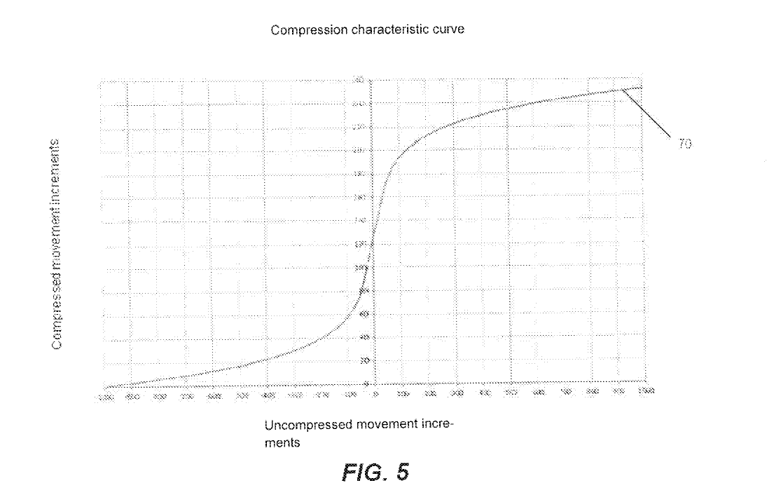

In step S430, a closest X coordinate from a non-linear characteristic curve is allocated to each input value from step S420, i.e., to each X and Y value individually, the characteristic curve being shown in detail in FIG. 5.

In FIG. 5, the reference numeral 70 denotes the non-linear compression characteristic curve.

The range of values to be transferred for uncompressed movement increments 90 can, as shown in FIG. 5, be from “−1000 counts to +1000 counts” along the X axis. In order to reduce a subsequent transfer of the values from the steering wheel electronics 40 to the display unit 50 to eight bits, the range of values of the uncompressed movement increments 90 of “−1000 counts to +1000 counts” is mapped to a range of values of compressed movement increments 80 along the Y axis in the range of “0 to 252”.

After step S430, the process flow advances to step S440.

In step S440, Y axis values which belong to the respective X axis value on the non-linear compression characteristic curve are used as output values for each of the X and Y values. After step S440, the process flow advances to step S450.

In step S450, the Y axis values determined previously, which are used as output values, are emitted. After step S450, the process flow advances to step S500 in FIG. 3.

In step S500, a digital signal containing the compressed movement coordinates is transferred from the steering wheel electronics 50 to the display unit 60.

More specifically, these values are transferred as 16-bit values via an interface to the steering wheels electronics 50.

After step S500, the process flow advances to step S600.

In step S600, the steering wheel electronics 50 reconstructs the movement increments from the transferred values by subtraction. In the display unit 60, after the transfer of the mapped values by the inverse mapping of the compressed data, the range of values of the compressed movement increments must be converted or mapped back from “0 to 252” to the range of values of the uncompressed movement increments “−1000 to +1000” by means of a non-linear decompression characteristic curve that is inverse to the non-linear compression characteristic curve 70.

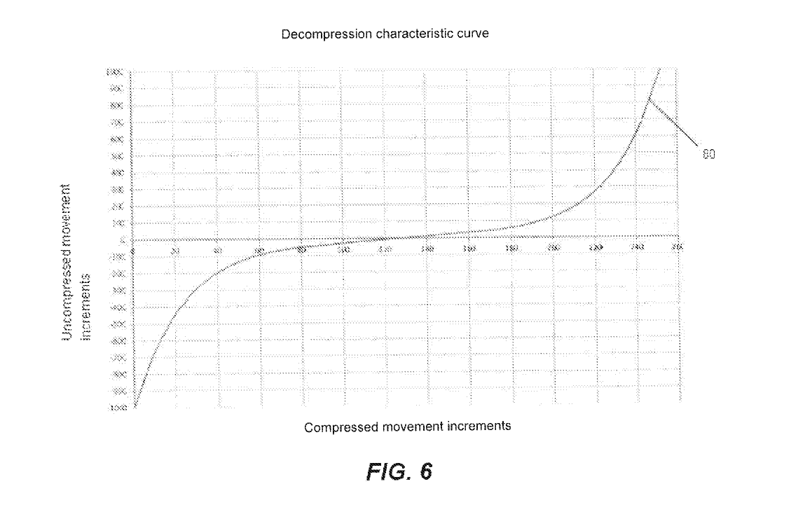

FIG. 6 shows a depiction of the non-linear decompression characteristic curve that is inverse to the non-linear compression characteristic curve in FIG. 5.

In FIG. 6, the reference numeral 80 denotes the non-linear decompression characteristic curve.

In order to implement this mapping, each movement coordinate in the X and Y direction, the respective closest X axis value, is allocated to each input value. The Y axis value associated with this X axis value must be used as an output value for the inverse mapping. During the mapping of the values and the inverse mapping of the values, as well as the transferring, this can lead to a discretisation error. This means that the starting values that are compressed and the values that are used after the decompression may potentially not be identical. Since a compression rate is chosen which keeps this error very small, this error falls below the perception threshold of each user, such that no anomalies in the display on the display unit 60 from the input of the user on the operating element 40 are visible to the driver as a result of the compression.

If, therefore, an input is actuated by the user which produces, after the calculation of the movement increments, an output value of “−200 counts”, the closest X axis value is allocated to this value with the aid of the non-linear compression characteristic curve 70, the X axis value having, for example, the Y axis value “40”.

This Y axis value is used as the output value for the transfer and is forwarded to the display unit 60. The display unit 60 reconstructs, with the aid of the non-linear decompression characteristic curve 80 that is inverse to the non-linear compression characteristic curve 70, the output value “40” and also assigns the closest Y axis value to this, which, without taking an error into consideration, in turn has the value “−200”.

After step S600, the process flow advances to step S700.

In step S700, the movement coordinates decompressed in step S600 are processed and the input carried out by the user is initiated or displayed on the display unit 60. After step S700, the process flow returns to step S100.

With this type of compression and decompression, the bandwidth for the transfer of the movement increments to the display unit 60 can be reduced to only eight bits.

The compression and decompression characteristic curves are configured in the previous exemplary embodiment in such a way that a predetermined percentage speed error is not exceeded by the transformation to and fro. Low speeds are thus resolved more finely than high speeds. For example, the characteristic curve can be configured in such a way that the speed error is 5% below the perception threshold of the user and the quantity of data per coordinate is able to be reduced to 8 bits. The transfer of movement coordinates of a finger on a data bus with low bandwidth is overall possible.

Although the present invention has been described previously with the aid of an exemplary embodiment, it is understood that different embodiments and amendments may be carried out without leaving the scope of the present invention, as is defined in the appended claims.

The disclosure of the drawings is exclusively referred to regarding further features and advantages of the present invention.

1.-12. (canceled)

13. A method for compressed transfer of signals of an operating element, having movement coordinates, to a display unit in a vehicle, comprising the steps of:
sending an optical signal to a surface of the operating element;
receiving an optical signal reflected by a finger of a user on the surface of the operating element in a predetermined scanning cycle;
converting the reflected optical signal into a digital signal that has relative movement coordinates of the finger in the predetermined scanning cycle in a first direction and in a second direction that is perpendicular to the first direction;
compressing the relative movement coordinates of the finger in the first direction and the second direction by a first non-linear compression characteristic curve for producing a compressed digital signal;
transferring the compressed digital signal to the display unit; and
decompressing the compressed digital signal in the display unit by a second non-linear decompression characteristic curve that is inverse to the first non-linear compression characteristic curve;
wherein the compressing is performed such that the digital signal is compressed more strongly with increasing speed depending on a speed derived from the relative movement coordinates.

14. The method according to claim 13, wherein the compressing and decompressing are performed such that a maximum error between a value of the digital signal and a value of a decompressed signal is less than or equal to five percent and the compressed digital signal has a maximum of 8 bits.

15. The method according to claim 13, wherein the decompressed digital signal in the display unit is represented as a movement of a pointer displayed in the display unit, a movement of a content displayed in the display unit, or a movement of a selection of menu items displayed in the display unit.

16. The method according to claim 13, wherein the operating element is disposed in a steering wheel of the vehicle and wherein the compressing is performed in an electronics unit of the steering wheel.

17. The method according to claim 13, wherein the operating element is an optical finger navigation module.

18. A device for compressed transfer of signals of an operating element, having movement coordinates, to a display unit in a vehicle, comprising:
a first device configured to send an optical signal to a surface of the operating element;
a second device configured to receive an optical signal reflected by a finger of a user on the surface of the operating element in a predetermined scanning cycle;
a third device configured to convert the reflected optical signal to a digital signal which has relative movement coordinates of the finger in the predetermined scanning cycle in a first direction and in a second direction that is perpendicular to the first direction;
a fourth device configured to compress the relative movement coordinates of the finger in the first direction and the second direction by a first non-linear compression characteristic curve to produce a compressed digital signal;
a fifth device configured to transfer the compressed digital signal to the display unit; and
a sixth device configured to decompress the compressed digital signal in the display unit by a second non-linear decompression characteristic curve that is inverse to the first non-linear compression characteristic curve;
wherein the fourth device is configured such that the digital signal is compressed more strongly with increasing speed depending on a speed derived from the relative movement coordinates.

19. The device according to claim 18, wherein a maximum error between a value of the digital signal and a value of a decompressed digital signal is less than or equal to five percent and the compressed digital signal has a maximum of 8 bits.

20. The device according to claim 18, wherein the display unit depicts a decompressed digital signal as a movement of a pointer displayed in the display unit, a movement of a content displayed in the display unit, or a movement of a selection of menu items displayed in the display unit.

21. The device according to claim 18, wherein the operating element is disposed in a steering wheel of the vehicle and wherein the fourth device is an electronics unit of the steering wheel.

22. The device according to claim 18, wherein the operating element is an optical finger navigation module.
